(19) United States
(12) Patent Application Publication
(10) Pub. No.: US 2021/0114324 A1
(43) Pub. Date: Apr. 22, 2021

(54) Process of making a sole having different properties

(71) Applicants: RunHong Liu, Dongguan (CN); DongQi Liu, Dongguan (CN); WeiDong Zhang, Dongguan (CN); Pete Humphrey, Seattle, WA (US); Bryan Bhark, Seattle, WA (US); Xiang Zhang, Seattle, WA (US)

(72) Inventors: RunHong Liu, Dongguan (CN); DongQi Liu, Dongguan (CN); WeiDong Zhang, Dongguan (CN); Pete Humphrey, Seattle, WA (US); Bryan Bhark, Seattle, WA (US); Xiang Zhang, Seattle, WA (US)

(21) Appl. No.: 17/134,560

(22) Filed: Dec. 28, 2020

(51) Int. Cl. B29D 35/12; B29D 35/00

(52) U.S. Cl. CPC B29D 35/122; B29D 35/128; B29D 35/0018

(57) ABSTRACT

A process of making a sole includes mixing a foaming material with a nucleating agent to form a plurality of local blanks belonging to different portions of a sole wherein the local blanks belonging to different portions have different ratios of the nucleating agent; injection molding the local blanks to form a plurality of cold molds which are joined together along a horizontal direction to form a sole blank; sulfurizing the sole blank; and subjecting the sole blank to supercritical foaming to produce a finished sole.

### BACKGROUND OF THE INVENTION

### 1. Field of the Invention

The invention relates to processes of making sole and more particularly to a process of making a sole having different properties in different portions.

### 2. Description of Related Art

Foaming materials, either natural or synthetic, are used for making soles for sports shoes, running shoes, etc. The soles are advantageous due to excellent elasticity, resistant to tear, strong, and resistant to wear.

EVA and TPU are foaming materials widely used for making soles including insoles, midsoles and outsoles due to excellent elasticity and rebounding capability. For a sole having multiple layers, the insole, the midsole and the outsole are made of different materials. This is because different portions of a sole are required to have different properties. For example, for a running shoe, the front portion of the sole is required to have increased elasticity for helping running, and the rear portion thereof is required to have increased shock absorbing capability for protecting the heel. However, there are no soles having different properties in different portions available in the market as aware by the present inventors.

A Chinese patent document discloses a process of making a sole having different densities and colors in different portions with no adhesive involved. While the sole has different densities in different portions, there is no property change in the different portions along a horizontal direction of the sole. Moreover, the process employs nucleating agent and grafting agent to adjust foaming ratios of different portions of the sole. However, different foaming ratios (i.e., extent of foaming) of the different portions adversely affect the joining stability of two adjacent layers.

Thus, the need for improvement still exists.

### SUMMARY OF THE INVENTION

The invention has been made in an effort to solve the problems of the conventional art by providing a process of making a sole having different properties in different portions having novel and nonobvious characteristics.

To achieve above and other objects of the invention, the invention provides a process of making a sole comprising the steps of mixing a foaming material with a nucleating agent to form a plurality of local blanks belonging to different portions of a sole wherein the local blanks belonging to different portions have different ratios of the nucleating agent; injection molding the local blanks to form a plurality of cold molds which are joined together along a horizontal direction to form a sole blank; sulfurizing the sole blank; and subjecting the sole blank to supercritical foaming to produce a finished sole.

Preferably, the local blanks includes a first local blank for a front portion of the sole, and a second local blank for a rear portion of the sole; the nucleating agent in the first local blank in the range between 2% and 4.5%; and the nucleating agent in the second local blank is in the range between 1% and 3%.

Preferably, the foaming material is ethylene-vinyl acetate (EVA), thermoplastic polyurethane (TPU), or a combination thereof.

Preferably, the nucleating agent is titanium dioxide, fine heavy calcium carbonate, nanometer superfine calcium carbonate, talc, or a combination thereof.

Preferably, the injection molding is performed at a temperature between 80° C. and 110° C.

Preferably, the sulfurization is performed at a temperature between 160° C. and 190° C. for a time period of between 300 seconds and 700 seconds.

Preferably, the supercritical foaming is performed by diffusing a supercritical fluid (SCF) through the sole blank at a predetermined pressure, and relieving the predetermined pressure to foam the sole blank, thereby producing the finished sole.

Preferably, the SCF is diffused at a pressure of between 10 Mpa and 18 Mpa for a time period of between 30 minutes and 60 minutes.

Preferably, the supercritical foaming is performed at a foaming ratio between 1.0 and 4.0.

The process of the invention has the following advantageous effects in comparison with the prior art: bores of the local blanks belonging to different portions can be changed by controlling ratios of the nucleating agent. Two local blanks belonging to different portions have different bores are formed. For example, one local blank is for a front portion of a sole and the other local blank is for a rear portion thereof. Thus, two portions of the sole along a horizontal direction having different properties meet the requirements.

### DETAILED DESCRIPTION OF THE INVENTION

A process of making a sole in accordance with the invention comprises the steps of (1) mixing a foaming material with a nucleating agent to form a plurality of local blanks belonging to different portions of a sole wherein the local blanks belonging to different portions have different ratios of nucleating agent; (2) injection molding the local blanks to form a plurality of cold molds which are joined together along a horizontal direction to form a sole blank; (3) sulfurizing the sole blank; and (4) subjecting the sole blank to supercritical foaming or pressing the sole blank to produce a finished sole.

In detail, bores of the local blanks belonging to different portions can be changed by controlling ratios of the nucleating agent. In step (1), the local blanks belonging to different portions have different bores so that two portions of the sole along a horizontal direction have different properties in order to meet the requirements. For example, one local blank is for a front portion of a sole and the other local blank is for a rear portion thereof in which one local blank has smaller bores, greater density, greater specific gravity, and greater elasticity and thus appropriate for running shoes; and the other local blank has larger bores, less density, less specific gravity, and increased shock absorbing capability and thus a wearer can feel a degree of comfort when wears shoes having the sole.

Foaming ratios of the local blanks are the same. Thus, the local blanks can be joined to increase stability.

Step (4) can be performed in a later time as a choice of the process.

Purpose of step (1) is to render bores of the local blanks belonging to different portions to be different with one another. Properties of the finished sole depend on types of the nucleating agent. Thus, the nucleating agent in one local blank can be the same as or different from that of another local blank depending on requirements.

The sulfurized sole blank has a three-dimensional structure and thus has increased elasticity, increased heat resistance, increased tension strength, and increased insolvability in an organic solution. Adjacent foamed particles are easier to join together so as to have an aesthetic appearance and prevent dust from entering gaps among the particles.

Preferably, in step (1), the nucleating agent in the local blank for a front portion of a sole is in the range between 2% and 4.5%; and the nucleating agent in the local blank for a rear portion of the sole is in the range between 1% and 3%.

Preferably, in step (1), the foaming material is ethylene-vinyl acetate (EVA), thermoplastic polyurethane (TPU), or a combination thereof.

Preferably, in step (1), the nucleating agent is titanium dioxide, fine heavy calcium carbonate, nanometer superfine calcium carbonate, talc, or a combination thereof. The local blanks forming step includes the sub-steps of forming foaming nucleus, growing and curing to form a predetermined shape in which the sub-step of foaming nucleus is critical for determining the number of bubbles and distribution thereof. The purpose of adding the nucleating agent in step (1) is to form foaming nucleus. Its principle is to take advantage of an interface between the nucleating agent and the molten material to form a plurality of points having low potential energy as nucleus. The smaller of the particles of the nucleating agent smaller density and more uniform of distribution of the bubbles of the finished sole will be. The nucleating agent, such as fine heavy calcium carbonate, is very useful in forming bubbles having smaller density and a uniform distribution.

Preferably, in step (1), a dyeing agent used in the forming of a local blank for a rear portion of a sole is different from that used in the forming of a local blank for a front portion of the sole. As a result, the two local blanks have different colors. Further, different portions of the finished sole have different colors for property identification.

Preferably, in step (2), the injection molding is performed at a temperature between 80° C. and 110° C.

Preferably, in step (3), the sulfurization is performed at a temperature between 160° C. and 190° C. for a time period of between 300 seconds and 700 seconds.

Preferably, in step (4), the supercritical foaming is performed to diffuse supercritical fluid (SCF) through the sole blank at a predetermined pressure. Then the pressure is relieved to foam the sole blank to produce a finished sole.

Preferably, the SCF is nitrogen in supercritical state, carbon dioxide in supercritical state, or a combination thereof.

Preferably, in step (4), the SCF is diffused at a pressure of between 10Mpa and 18Mpa for a time period of between 30 minutes and 60 minutes.

Preferably, in step (4), a hydraulic machine is used to press the sole blank to produce a finished sole. Being different from the supercritical foaming, the hydraulic machine presses the sole blank to produce a finished sole having increased density.

Preferably, the supercritical foaming is performed at a foaming ratio between 1.0 and 4.0. More preferably, the foaming ratio is in the range between 1.5 and 1.6.

### Embodiment 1

In the embodiment, the process of making a sole comprises the steps of mixing EVA with fine heavy calcium carbonate to form a first local blank for a front portion of a sole and a second local blank for a rear portion of the sole wherein the nucleating agent in the first local blank for the front portion of the sole is 3%, and the nucleating agent in the second local blank for the rear portion of the sole is 2%; (2) injection molding the first and second local blanks at a temperature of 90° C. to form two cold molds which are joined together to form a sole blank; (3) sulfurizing the sole blank at a temperature of 180° C. for 500 seconds; and (4) subjecting the sole blank to carbon dioxide in supercritical state keeping at a pressure of 14 Mpa for 50 seconds, and releasing pressure to foam the sole blank, thereby producing a finished sole. The foaming ratio is 1.5.

Bores of bubbles of the first local blank for the front portion of the sole and bores of bubbles of the second local blank for the rear portion of the sole are measured by an optical microscope respectively. Rebounding capability of the first local blank for the front portion of the sole and rebounding capability of the second local blank for the rear portion of the sole are measured by a strain gauge respectively. Density of the first local blank for the front portion of the sole and density of the second local blank for the rear portion of the sole are measured by a specific gravity scale respectively. Hardness of the first local blank for the front portion of the sole and hardness of the second local blank for the rear portion of the sole are measured by a hardness tester respectively. Test results show for the first local blank for the front portion of the sole, bore of the bubble is 0.5 mm, rebounding capability is 62%, density (i.e., specific gravity) is 0.16 g/cm³ and hardness is 50 kgHC; and for the second local blank for the rear portion of the sole, bore of the bubble is 1.6 mm, rebounding capability is 52%, density (i.e., specific gravity) is 0.14 g/cm³ and hardness is 40 kgHC.

### Embodiment 2

The characteristics of the embodiment 2 are substantially the same as that of the embodiment 1 except the following: In step (4), a hydraulic machine is used to press the sole blank to produce a finished sole. Test results show for the first local blank for the front portion of the sole, bore of the bubble is 0.4 mm, rebounding capability is 63%, density (i.e., specific gravity) is 0.16 g/cm³ and hardness is 53 kgHC; and for the second local blank for the rear portion of the sole, bore of the bubble is 1.6 mm, rebounding capability is 52%, density (i.e., specific gravity) is 0.14 g/cm³ and hardness is 38 kgHC.

### Embodiment 3

The characteristics of the embodiment 3 are substantially the same as that of the embodiment 1 except the following: In step (2) the injection molding is performed at a temperature of 70° C. Test results show the first and second local blanks are poor in quality, low joining capability, loose and difficult of shaping.

### Embodiment 4

The characteristics of the embodiment 4 are substantially the same as that of the embodiment 1 except the following: In step (3) the sulfurization is performed at a temperature of 150° C. Test results show the sulfurized sole blank has a low yield, low joining capability, rough surface and significant defects.

### Embodiment 5

The characteristics of the embodiment 5 are substantially the same as that of the embodiment 1 except the following: In step (3) the sulfurization is performed for 250 seconds. Test results show the sulfurized sole blank has a low yield, low joining capability of particles, and rough surface.

### Embodiment 6

The characteristics of the embodiment 6 are substantially the same as that of the embodiment 1 except the following: In step (4) a hydraulic machine is used to press the sole blank to produce a finished sole. Test results show quality of the finished sole is very high.

### Embodiment 7

The characteristics of the embodiment 7 are substantially the same as that of the embodiment 1 except the following: In step (4) the SCF is at a pressure of 8Mpa. Test results show the foaming is not complete, i.e., partially foamed because the SCF (i.e., the gaseous nucleating agent) does not completely diffuse through the sole blank.

### Embodiment 8

The characteristics of the embodiment 8 are substantially the same as that of the embodiment 1 except the following: In step (4) the pressure of the sulfurization is kept for 20 seconds. Test results show the finished sole has a rough surface and low joining capability in its internal construction.

### Embodiment 9

The characteristics of the embodiment 9 are substantially the same as that of the embodiment 1 except the following: In step (4) the foaming ratio is 1.3. Test results show the finished sole has a very large density due to insufficient foaming ratio.

### Embodiment 10

The characteristics of the embodiment 10 are substantially the same as that of the embodiment 1 except the following: In step (4) the foaming ratio is 8. Test results show the finished sole has a very small density due to excessive foaming ratio.

### Embodiment 11

The characteristics of the embodiment 11 are substantially the same as that of the embodiment 1 except the following: In step (1) the local blank belonging to the front portion of the sole has a 5% ratio of nucleating agent. Test results show quality of the finished sole is low because the density of the local blanks is too large and the hardness thereof is also too large.

### Embodiment 12

The characteristics of the embodiment 12 are substantially the same as that of the embodiment 1 except the following: In step (1) the local blank belonging to the rear portion of the sole has a 0.3% ratio of nucleating agent. Test results show quality of the finished sole is low because the bores of the bubbles in the local blanks are insufficient.

While the invention has been described in terms of preferred embodiments, those skilled in the art will recognize that the invention can be practiced with modifications within the spirit and scope of the appended claims.

What is claimed is:

1. A process of making a sole, comprising the steps of:
(1) mixing a foaming material with a nucleating agent to form a plurality of local blanks belonging to different portions of a sole wherein the local blanks belonging to different portions have different ratios of the nucleating agent;
(2) injection molding the local blanks to form a plurality of cold molds which are joined together along a horizontal direction to form a sole blank;
(3) sulfurizing the sole blank; and
(4) subjecting the sole blank to supercritical foaming to produce a finished sole.

2. The process of claim 1, wherein the local blanks includes a first local blank for a front portion of the sole, and a second local blank for a rear portion of the sole; wherein the nucleating agent in the first local blank in the range between 2% and 4.5%; and wherein the nucleating agent in the second local blank is in the range between 1% and 3%.

3. The process of claim 1, wherein the foaming material is ethylene-vinyl acetate (EVA), thermoplastic polyurethane (TPU), or a combination thereof.

4. The process of claim 1, wherein the nucleating agent is titanium dioxide, fine heavy calcium carbonate, nanometer superfine calcium carbonate, talc, or a combination thereof.

5. The process of claim 1, wherein the injection molding is performed at a temperature between 80° C. and 110° C.

6. The process of claim 1, wherein the sulfurization is performed at a temperature between 160° C. and 190° C. for a time period of between 300 seconds and 700 seconds.

7. The process of claim 1, wherein the supercritical foaming is performed by diffusing a supercritical fluid (SCF) through the sole blank at a predetermined pressure, and relieving the predetermined pressure to foam the sole blank, thereby producing the finished sole.

8. The process of claim 7, wherein the SCF is diffused at a pressure of between 10 Mpa and 18 Mpa for a time period of between 30 minutes and 60 minutes.

9. The process of claim 1, wherein the supercritical foaming is performed at a foaming ratio between 1.0 and 4.0.
